(19) United States
(12) Patent Application Publication
(10) Pub. No.: US 2017/0334079 A1
(43) Pub. Date: Nov. 23, 2017

(54) DEVICE FOR REMOVING LINT FROM THE SURFACE OF A FABRIC ARTICLE

(71) Applicant: KONINKLIJKE PHILIPS N.V., EINDHOVEN (NL)

(72) Inventors: LUCK WEE PNG, EINDHOVEN (NL); BOON KHIAN CHING, EINDHOVEN (NL)

(21) Appl. No.: 15/129,959

(22) PCT Filed: Feb. 1, 2016
(86) PCT No.: PCT/EP2016/052052

§ 371 Date: Sep. 28, 2016

(30) Foreign Application Priority Data
Feb. 3, 2015 (EP) 15153530.9

(51) Int. Cl. B26B 19/48; A47L 25/08; B26B 19/38; B26B 19/44

(52) U.S. Cl. CPC B26B 19/48; B26B 19/44; A47L 25/08; B26B 19/3853

(57) ABSTRACT

The present application relates to a device (1) for removing lint from the surface of a fabric article. The device comprises a housing (2), a collection chamber (6) within the housing (2) and a rotating element (4) mounted to the housing (2) that is positionable in the vicinity of the surface of a fabric article when the housing (2) is held in a first orientation to remove lint from the surface and transport it to the collection chamber (6). A trimmer assembly (5) is mounted to the housing (2) and comprises a blade (7) for application to the surface of a fabric article when the housing (2) is held in a different orientation to cut lint forming fibres. A method of using the device (1) is also disclosed.

### FIELD OF THE INVENTION

The present invention relates to a device for removing lint from the surface of a fabric article. A method of using the device is also disclosed.

### BACKGROUND OF THE INVENTION

Certain materials or fabrics, especially those used in the manufacture of clothing, such as cotton, linen and wool, contain numerous, short fibres bundled together. During the course of normal wear, these fibres become detached or at least partially dislodged from the weave of which they originally formed an integral part. The common name for this accumulation of textile fibres on the surface of a fabric is ‘lint’. Lint that forms on clothing is generally regarded as being unattractive and so there is a desire to remove it. Commonly, lint is removed using a clothes brush or a roller with adhesive tape. Specialised lint removal devices are also known and successfully pick up loose lint present on the surface of a garment. However, conventional lint removers struggle to remove dense lint or fibres that have only been partially dislodged.

A device for removing ‘pills’, i.e. small balls or groups of fibres that accumulate on a fabric, which aims to overcome or alleviate the problems referred to above, is described in JPH01132867A. The device described in this document is provided with a primary cutting blade 1 and a secondary trimmer blade 2. In use, the device is drawn across the surface of a fabric being treated so that the trimmer blade 2 cuts the long pills in order to shorten them and the shortened pills are subsequently cut by the primary blade 1, located directly behind the trimmer blade 2. The device known from this document may cut and remove too many fibres resulting in a non-uniform surface and damage to the look and feel of the fabric.

### SUMMARY OF THE INVENTION

It is an object of the invention to provide a lint removal device which substantially alleviates or overcomes the problems mentioned above.

According to the present invention, there is provided a device for removing lint from the surface of a fabric article, comprising:

a housing,

a collection chamber within the housing,

a rotatable element mounted to the housing and positionable in the vicinity of the surface of the fabric article when said housing is in a first orientation to remove lint from said surface and transport the removed lint to said collection chamber,

a trimmer assembly mounted to the housing and comprising a blade for application to said surface when said housing is held in a second orientation to cut lint forming fibres.

The device according to the invention defines a compact two-in-one device to remove lint at the surface of a fabric, or to cut lint forming fibres at the surface of the fabric. This device allows dense lint to be removed whilst also minimising or eliminating the chances that the fabric being treated will be damaged.

In a preferred embodiment, the trimmer assembly is movable between a stowed position compared to the housing and an operational position in which the trimmer assembly extends from said housing.

This ensures that the trimmer assembly does not get in the way when it is not in use and also provides additional protection for the blade when the trimmer assembly is in its stowed position.

Alternatively, the trimmer assembly may be releasably attachable to the housing in an operational position.

The trimmer assembly may, for example, be a ‘snap fit’ onto the housing of the device, thereby making it easy to attach and re-attach. The blade may drivingly couple with the drive mechanism as a result of being attached to the housing, thereby minimising any additional steps for the user and making the device very simple and straightforward to operate.

In a preferred embodiment, the device comprises a drive mechanism operable to drive the rotating element and the blade. The trimmer assembly may be configured so that the blade cooperates with the drive mechanism when the trimmer assembly is in its operational position to actuate the blade.

This avoids the requirement to provide a separate switch for the trimmer assembly as it will activate automatically when it is in its operational position.

Preferably, the drive mechanism comprises a primary drive shaft for driving the blade.

In a preferred embodiment, the trimmer assembly has a secondary drive shaft, the primary drive shaft and secondary drive shaft being coupled by a gear train such that an axis of rotation of the secondary drive shaft extends in a radial direction away from an axis of rotation of the primary drive shaft.

In this way, the primary drive shaft drives both the rotary element and the trimmer assembly.

In a preferred embodiment, the blade is a reciprocating blade.

A reciprocating blade provides an effective cutting action to remove more dense lint.

A converter coupling is preferably located between the secondary drive shaft and the reciprocating blade, the converter coupling being operable to convert rotary motion of the secondary drive shaft to linear motion of the reciprocating blade.

In a preferred embodiment, the primary drive shaft is advantageously configured to drive both the blade and the rotating element.

The drive mechanism may comprise a dual shaft motor having a first shaft and a second shaft, said first shaft forming a first section of the primary drive shaft, said second shaft forming a second section of the primary drive shaft.

By using a dual shaft motor, only a single motor is required thereby simplifying the device and enabling its size to be kept small.

In another embodiment, the drive mechanism may comprise a first motor, the primary drive shaft extending from said first motor for driving the blade and, a second motor having a separate drive shaft for driving the rotating element.

In this case, the device advantageously comprises a switch to control the first motor and the second motor independently of each other.

In any embodiment, the trimmer assembly advantageously comprises a blade guard surrounding the blade.

The blade guard protects the blade, provides a safety feature to prevent the user from injury and also serves to space the blade from the fabric surface to prevent excessive fibre removal.

According to another aspect of the invention, there is provided a method of removing lint from the surface of a fabric article using the lint removal device according to any preceding claim, comprising the step of reorienting the device relative to a fabric surface being treated to bring either the rotatable element or the blade of the trimmer assembly into an operational position in the vicinity of the surface of the fabric article from which lint is to be removed.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 illustrates a lint removal device, according to a first preferred embodiment of the present invention, in which the device is shown in a first orientation relative to a fabric surface;

FIG. 2 illustrates the lint removal device of FIG. 1 in which the device is shown in a second orientation relative to the fabric surface;

FIG. 3 illustrates a lint removal device according to a second preferred embodiment of the present invention in which the device is shown in a first orientation relative to a fabric surface;

FIG. 4 illustrates the lint removal device of FIG. 3 in which the device is shown in a second orientation relative to the fabric surface.

### DETAILED DESCRIPTION OF THE EMBODIMENTS

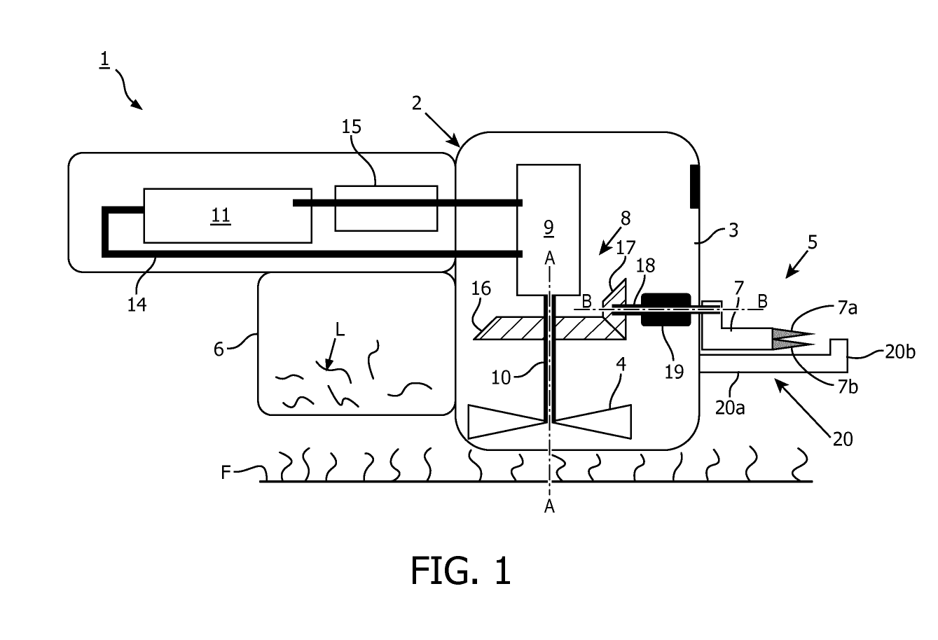

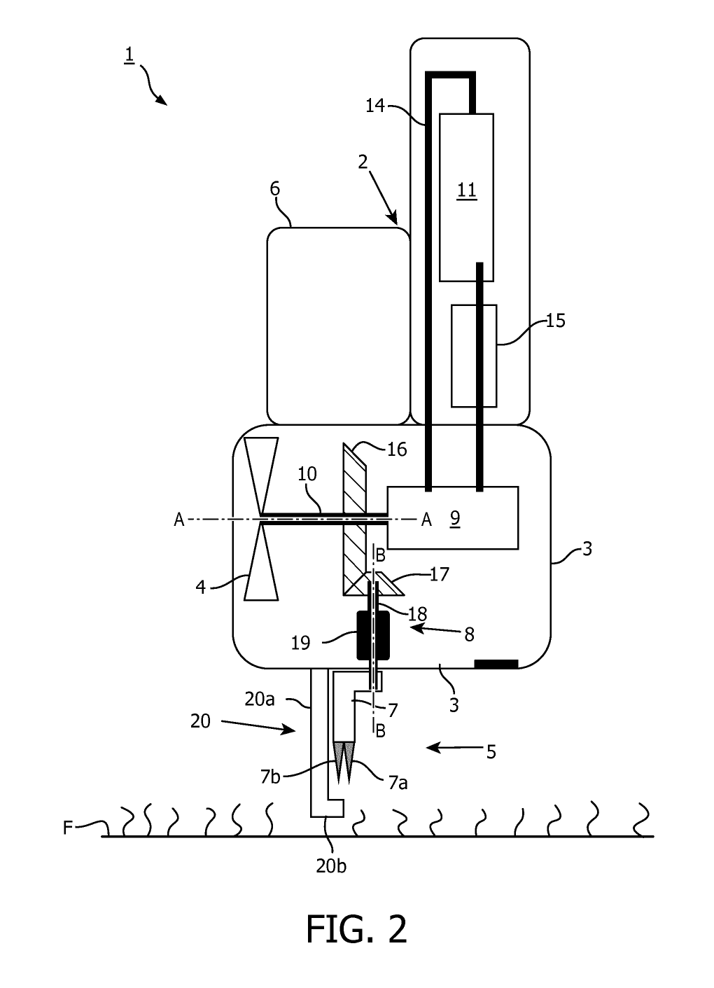

There is shown in FIGS. 1 and 2 a lint removal device 1 according to a first embodiment of the invention.

The device 1 comprises a housing 2 that preferably includes a main body 3, a rotatable element 4 mounted to the housing 2 and a trimmer assembly 5. The housing 2 also includes a collection chamber 6 for collecting lint ‘L’ removed from a fabric surface ‘F’ The lint collection chamber 6 is preferably detachable from the remainder of the housing 2 to enable it to be periodically emptied of collected lint ‘L’.

A rotatable element 4 can be found on lint removal devices and they comprise, for example, a disc or arm mounted to the end of a drive shaft that extends at right angles to the axis of rotation of the drive shaft. One or more cutting blades protrude axially from the disc or arm, which also extend in a radial direction from the axis so that, as the disc or arm rotates, the blade sweeps through a circular path and fibres in the path of the rotating blade are cut. Rotation of the disc or arm also generates a low level vacuum sufficient to draw or suck loose lint towards it. Upon contact with the fibres, the blades flick the lint in a radial direction and into the collection chamber 6. A rotatable element 4 is adequate for cutting thinner, less dense, fibres and for collecting loose fibres from a fabric surface. However, rotatable elements 4 on lint removal devices generally suffer from the problem that they cannot cut more densely grouped fibres or thicker individual fibres present on the fabric surface F. As the rotatable element 4 is a commonly known component of lint removal devices, it will not be described here in further detail.

The trimmer assembly 5 has a blade 7 and may be releasably attached to the main body 3 by, for example, a snap-fit type connection, although it is envisaged that it will preferably be mounted to the main body 3 so that it is movable between stowed and operational positions. FIGS. 1 and 2 show the trimmer assembly 5 in its operational position in which it protrudes from the main body 3 so that, when it is held relative to the surface of the fabric F in the position shown in FIG. 2, the blade 7 will cut fibres protruding from the fabric surface F. However, when the trimmer assembly 5 is in a stowed position, it may be held within or against the main body 3 so that it does not protrude from the main body 3 or protrudes from the main body 3 to a lesser extent than when it is in its operational position. Preferably, the trimmer assembly 5 is locked in its stowed position and can be moved into its operational position upon release by a user.

The trimmer assembly 5 is preferably pivotally or slideably mounted to the main body 3 of the housing so as to be moveable between its stowed and operational positions as indicated above. The trimmer assembly 5 may also be mounted so that it is biased by a spring member (not shown) into an operational position. In this case, the trimmer assembly 5 may be held in its stowed position against the bias provided by the spring member by a catch which is released by a user to cause the trimmer assembly 6 to ‘pop-up’ into its operational position.

The housing 2 contains a drive mechanism 8 for driving the rotatable element 4 and the blade 7. The drive mechanism 8 preferably includes a drive motor 9 with a primary drive shaft 10 that rotates about an axis A-A. The rotatable element 4 is preferably mounted to the free end of the primary drive shaft 10 and rotates in response to operation of the drive motor 9. The drive motor 9 is preferably connected to a battery chamber 11 and batteries received therein via an electrical circuit 14 that preferably includes a switch 15.

A gear train comprising a first gear 16 and a second gear 17 transmits drive from the primary drive shaft 10 to a secondary drive shaft 18 of the trimmer assembly 5. The first gear 16 is preferably mounted on the drive shaft 10 between the drive motor 9 and the rotatable element 4 and preferably rotates together with the drive shaft 10. The second gear 17 is mounted for rotation together with said secondary drive shaft 18 and lies in meshing engagement with the first gear 16. The secondary drive shaft 18 preferably rotates about an axis B-B that extends at right angles to axis A-A, as shown in FIGS. 1 and 2, although the angle between the axes A-A and B-B may also be less than 90 degrees. As shown in the Figures, the first and second gears 16, 17 are preferably spiral bevel gears, as these can be used to provide a convenient way of altering the drive angle, although alternative gear forms are also envisaged.

The blade 7 is preferably a reciprocating blade which is preferably mounted to the remote end of the secondary drive shaft 18 via a converter coupling 19 or linear actuator which serves to convert rotary motion of the secondary drive shaft 18 into a linear or lateral sliding motion. A reciprocating blade 7 provides a more effective cutting action than the conventional cutting action provided by the rotatable element 4. The reciprocating blade 7 may function in a similar way to the trimmer function found on conventional hair shaving devices. For example, the reciprocating blade 7 may preferably comprise a pair of toothed blade elements 7a, 7b, one of which remains fixed relative to the other blade element 7a,7b, so that the moving blade element 7a moves across the stationary blade element 7b in order to create a cutting action and cut any fibres that are received between the teeth of the cutting elements 7a,7b as the device is drawn across the surface of the fabric article F and the teeth slide across each other. The moving blade element 7a preferably reciprocates in a direction into, and out of, the page as shown in FIGS. 1 and 2.

The converter coupling 19 may comprise a slider-crank type mechanism to convert the rotation of the secondary drive shaft 18 into reciprocating or sliding motion of the reciprocating blade 7. Alternatively, the converter coupling 19 can be a traditional scotch yoke or slotted link mechanism in which the reciprocating blade 7 is coupled to a sliding yoke having a slot which engages a pin extending from the end of a crank mounted to the secondary drive shaft 18.

It is also envisaged that the drive mechanism 8 will preferably only be in engagement with the reciprocating blade 7 of the trimmer assembly 5 when the trimmer assembly 5 is in its operational position. For example, when the trimmer assembly 5 is folded into its stowed position, the reciprocating blade 7 preferably automatically becomes decoupled from the converter coupling 19 or, the gears 16, 17 come out of meshing engagement as a result of moving the trimmer assembly 5 into its stowed position, so that the reciprocating blade 7 no longer reciprocates until it is returned to its operational position. As the reciprocating blade 7 automatically starts reciprocating once the trimmer assembly 5 is moved into its operational position, a single on/off switch may be used to control both the rotatable element 4 and the reciprocating blade 7, making the device simple and intuitive to use. However, it will be appreciated that two separate switches for each of the reciprocating blade 7 and the rotatable element 4 could also be employed.

The trimmer assembly 5 preferably includes a blade guard 20 that has a leg 20a extending from the housing and preferably has a foot 20b extending from a remote end of the leg 20a that surrounds the reciprocating blade 7 whilst still allowing it to cut lint in its path. Preferably, the blade guard 20 partially surrounds the blade 7 so that the blade 7 is at least partially open or accessible in a direction facing the direction of movement across the fabric surface. When the trimmer assembly 5 is in use and is held in the position shown in FIG. 2, the foot 20b may be placed against the surface of the fabric article F in order to maintain a constant spacing between the reciprocating blade 7 and the fabric article F to ensure that only fibres or lint L that protrudes above the fabric surface beyond a particular distance will be cut by the reciprocating blade 7. The blade guard 20 therefore prevents excessive fibre removal which would otherwise damage the fabric surface F.

It will be appreciated that, because of the relative positions of the rotary element 4 and the trimmer assembly 5, they must be applied to the surface of the fabric F independently and separately to each other. FIG. 1 shows the device 1 in a first orientation in which it is positioned relative to the surface of the fabric F so that the rotatable element 4 is capable of collecting lint from the surface and transporting it to the collection chamber 6, as well as cutting and removing less dense fibres. In order to use the trimmer assembly 5, the device 1 must be re-oriented into the position shown in FIG. 2 relative to the fabric surface F, so that the trimmer assembly 5 can now be used to cut more stubborn and dense fibres, prior to using the rotary element 4 to collect the cut fibres from the fabric surface F.

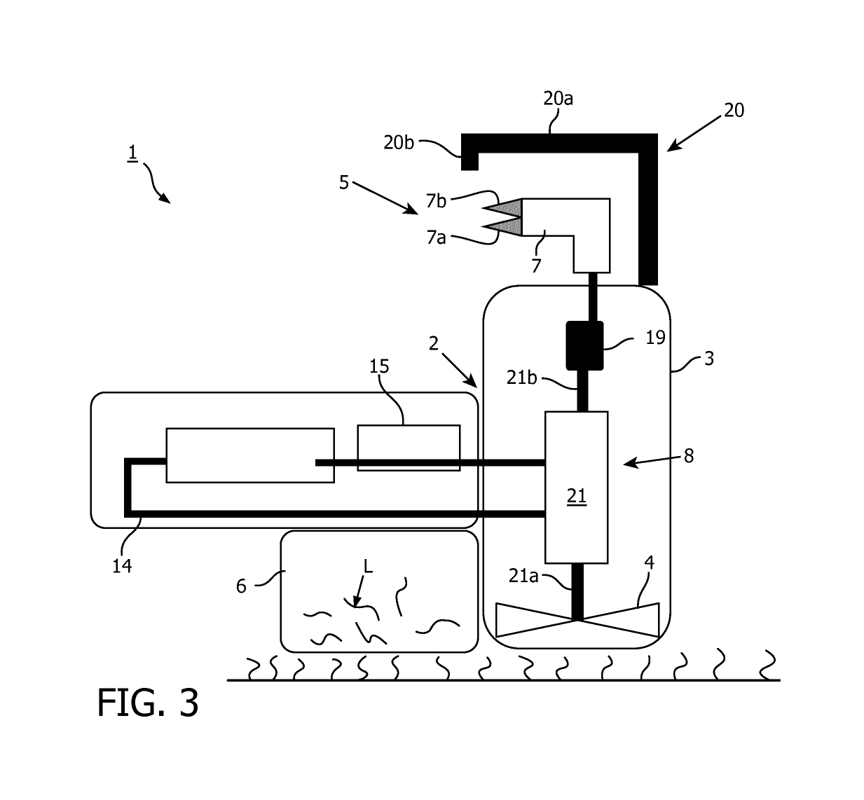

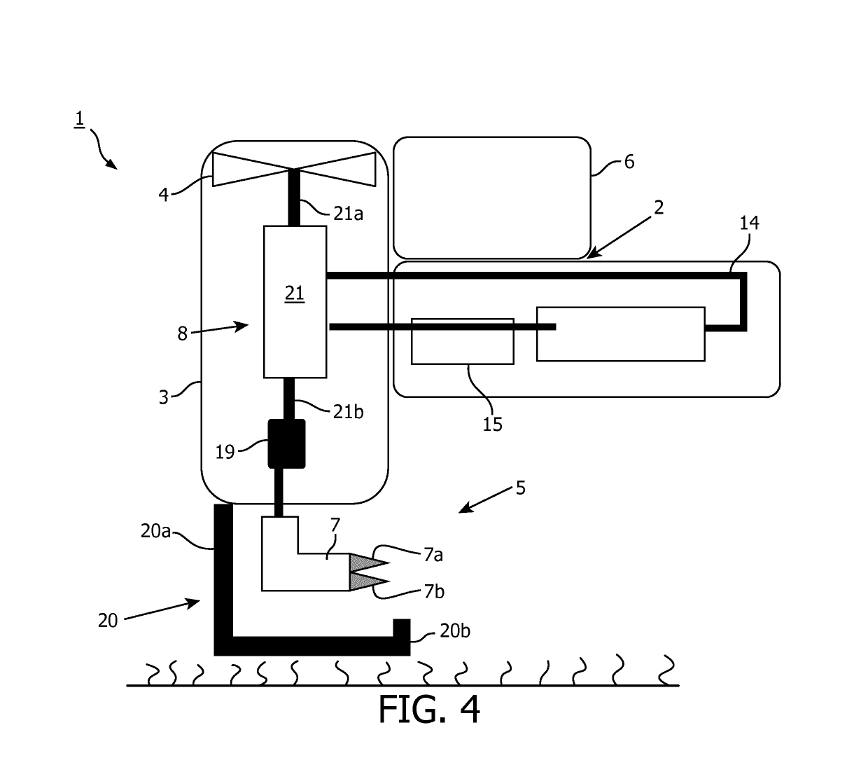

FIGS. 3 and 4 shows an alternative embodiment, which is similar to the embodiment of FIGS. 1 and 2 except in the arrangement of the drive mechanism 8. In this embodiment, a motor 21 having a dual drive shaft is preferably employed. The motor has a first shaft 21a and a second shaft 21b beach of which extend from opposite sides of the motor 21. The first shaft 21a forms a first section of the primary drive shaft 10 and the rotary element 4 is preferably connected to the remote end of the first shaft 21a. The reciprocating blade 7 of the trimmer assembly 5 is preferably connected to the remote end of the second section 21b of the primary drive shaft 10 via a converter coupling 19 to convert rotary motion of the second section 21b to translational or reciprocal motion of the blade 7 of the trimmer assembly 5.

In another, unillustrated embodiment, the rotary element 4 and the reciprocating blade 7 are each preferably driven via a dedicated motor, each having its own drive shaft. In this case, each motor preferably has its own switch so that the reciprocating blade 7 and the rotary element 5 can be switched on and off independently to each other.

The above embodiments as described are only illustrative, and not intended to limit the technique approaches of the present invention. Although the present invention is described in details referring to the preferable embodiments, those skilled in the art will understand that the technique approaches of the present invention can be modified or equally displaced without departing from the spirit and scope of the technique approaches of the present invention, which will also fall into the protective scope of the claims of the present invention. In the claims, the word “comprising” does not exclude other elements or steps, and the indefinite article “a” or “an” does not exclude a plurality. Any reference signs in the claims should not be construed as limiting the scope.

1. A device for removing lint from the surface of a fabric article, comprising:
housing,
a collection chamber within the housing,
a rotatable element mounted to the housing and positionable in the vicinity of the surface of the fabric article when said housing is in a first orientation to remove lint from said surface and transport the removed lint to said collection chamber,
a trimmer assembly mounted to the housing and comprising a blade for application to said surface when said housing is in a second orientation to cut lint forming fibres.

2. A device according to claim 1, wherein the trimmer assembly is movable between a stowed position compared to the housing and an operational position in which the trimmer assembly extends from said housing.

3. A device according to claim 1, wherein the trimmer assembly is releasably attachable to the housing in an operational position.

4. A device according to claim 2, comprising a drive mechanism operable to drive the rotatable element and the blade, the trimmer assembly being configured so that the blade cooperates with said drive mechanism when the trimmer assembly is in its operational position to actuate the blade.

5. A device according to claim 4, wherein the drive mechanism comprises a primary drive shaft for driving the rotatable element.

6. A device according to claim 5, wherein the trimmer assembly has a secondary drive shaft, the primary drive shaft and the secondary drive shaft being coupled by a gear train such that an axis of rotation of the secondary drive shaft extends in a radial direction away from an axis of rotation of the primary drive shaft.

7. A device according to claim 1, wherein the blade is a reciprocating blade.

8. A device according to claim 7, comprising a converter coupling located between the secondary drive shaft and the reciprocating blade, the converter coupling being operable to convert rotary motion of the secondary drive shaft to linear motion of the reciprocating blade.

9. A device according to claim 5, wherein the primary drive shaft is configured to drive both the blade and the rotating element.

10. A device according to claim 9, wherein the drive mechanism comprises a dual shaft motor having a first shaft and a second shaft, said first shaft forming a first section of the primary drive shaft, said second shaft forming a second section of the primary drive shaft.

11. A device according to claim 4, wherein the drive mechanism comprises a first motor, the primary drive shaft extending from said first motor for driving the blade and, a second motor having a separate drive shaft for driving the rotating element.

12. A device according to claim 10, comprising a switch to control the first motor and second motor independently of each other.

13. A device according to claim 1, wherein the trimmer assembly comprises a blade guard surrounding the blade.

14. A method of removing lint from the surface of a fabric article using the lint removal device according to claim 1, comprising the step of reorienting the device relative to a fabric surface being treated to bring either the rotatable element or the blade of the trimmer assembly into an operational position in the vicinity of the surface of the fabric article from which lint is to be removed.
